(19) United States
(12) Patent Application Publication
(10) Pub. No.: US 2024/0031957 A1
(43) Pub. Date: Jan. 25, 2024

(54) HYBRID SYNCHRONIZATION METHOD AND HYBRID SYNCHRONIZATION APPARATUS

(71) Applicant: GEOPLAN CO., LTD., Anseong-si Gyeonggi-do (KR)

(72) Inventor: Jisung KIM, Suwon-si Gyeonggi-do (KR)

(21) Appl. No.: 18/267,089

(22) PCT Filed: Dec. 24, 2020
(86) PCT No.: PCT/KR2020/019056

§ 371 Date: Jun. 13, 2023

(30) Foreign Application Priority Data
Dec. 17, 2020 (KR) 10-2020-0177843

(51) Int. Cl. H04W 56/00

(52) U.S. Cl. CPC H04W 56/0015; H04W 56/006

(57) ABSTRACT

Disclosed are a hybrid synchronization method and a hybrid synchronization apparatus for locally and autonomously synchronizing clock information with a master anchor on the basis of a master sync signal for each of a plurality of slave anchors that communicates with the master anchor provided for each cell in order to perform wired/wireless hybrid synchronization for a real-time locating system (RTLS) based on an ultra-wideband (UWB), transmitting a time difference between reception times of the sync signals that are respectively received from the plurality of master anchors only in a multi-slave anchor that communicates with the plurality of master anchors to a location engine so that the location engine generates an offset value for synchronizing the master anchors, and performing wired synchronization between a part of the master anchors.

### TECHNICAL FIELD

The present inventive concept relates to a hybrid synchronization method and a hybrid synchronization apparatus.

### BACKGROUND ART

The content described below merely provides background information related to the present inventive concept.

A real-time locating system (RTLS) is a system that identifies the location of a person or object in real time on the basis of a specific technology. Such an RTLS is applied using a radio frequency identification (RFID) technology or a wireless LAN technology, and may be applied to various fields depending on purposes.

In order to apply the RTLS, an RTLS transmitter (for example, an RFID tag) is attached to each object. An RTLS receiver (for example, an RFID reader) wirelessly recognizes a unique identifier (ID) of an object to which the RTLS transmitter is attached. The RTLS collects, stores, processes, and tracks unique identifiers collected by the RTLS receivers to provide positioning services for objects. Here, in order to determine the location of the RTLS transmitter, the RTLS receiver recognizes the location of the RTLS transmitter using location information including a signal intensity, a signal arrival time, and a signal reception direction on the basis of reception of radio waves from the RTLS transmitter.

In order to recognize the location of the RTLS transmitter, it is necessary that the RTLS receiver is synchronized at a precise standard time, but there is a nanoscale error range.

### DISCLOSURE

### Technical Problem

The present inventive concept has been made in view of the above problems, and it is an object of the present inventive concept to provide a hybrid synchronization method for locally and autonomously synchronizing clock information with a master anchor on the basis of a master sync signal for each of a plurality of slave anchors that communicates with the master anchor provided for each cell in order to perform wired/wireless hybrid synchronization for a real-time locating system (RTLS) based on an ultra-wideband (UWB); transmitting a time difference between reception times of the sync signals that are respectively received from the plurality of master anchors only in a multi-slave anchor that communicates with the plurality of master anchors to a location engine so that the location engine generates an offset value for synchronizing the master anchors; and performing wired synchronization between a part of the master anchors, and a hybrid synchronization apparatus therefor.

### Technical Solution

In accordance with an aspect of the present inventive concept, there is provided a hybrid synchronization apparatus including: a clock generator that generates a clock sync signal at a preset cycle; a first master anchor that is connected to the clock generator in a wired manner to receive the clock sync signal, synchronizes clock information on the basis of the clock sync signal, and broadcasts the clock sync signal in a wireless manner to surroundings in a cell unit; a first slave anchor that receives the clock sync signal from the first master anchor, and locally and autonomously synchronizes clock information with the first master anchor on the basis of the clock sync signal; a first multi-slave anchor that calculates a first difference value between reception times of the clock sync signals that are respectively received from the first master anchor and an N-th master anchor for transmission; a second master anchor that is connected to the first master anchor in a wired manner to receive the clock sync signal, synchronizes clock information on the basis of the clock sync signal, and broadcasts the clock sync signal in a wireless manner to surroundings in a cell unit; a second slave anchor that receives the clock sync signal from the second master anchor, and locally and autonomously synchronizes clock information with the second master anchor on the basis of the clock sync signal; a second multi-slave anchor that calculates a second difference value between reception times of the clock sync signals that are respectively received from the second master anchor and an M-th master anchor for transmission; and a location engine that converts the first difference value and the second difference value into an offset value, and synchronizes the difference values between the master anchors of different cells on the basis of the offset value.

In accordance with another aspect of the present inventive concept, there is provided a hybrid synchronization method including: generating a clock sync signal at a preset cycle, by a clock generator; receiving the clock sync signal from the clock generator that is connected in a wired manner, synchronizing clock information on the basis of the clock sync signal, and broadcasting the clock sync signal in a wireless manner to surroundings in a cell unit, by a first master anchor; receiving the clock sync signal from the first master anchor, and locally and autonomously synchronizing clock information with the first master anchor on the basis of the clock sync signal, by a first slave anchor; calculating a first difference value between reception times of the clock sync signals that are respectively received from the first master anchor and an N-th master anchor for transmission, by a first multi-slave anchor; receiving the clock sync signal from the first master anchor that is connected in a wired manner, synchronizing clock information on the basis of the clock sync signal, and broadcasting the clock sync signal in a wireless manner to surroundings in a cell unit, by a second master anchor; receiving the clock sync signal from the second master anchor, and locally and autonomously synchronizing clock information with the second master anchor on the basis of the clock sync signal, by a second slave anchor; calculating a second difference value between reception times of the clock sync signals that are respectively received from the second master anchor and an M-th master anchor for transmission, by a second multi-slave anchor; and converting the first difference value and the second difference value into an offset value, and synchronizing the difference values between the master anchors of different cells on the basis of the offset value, by a location engine.

### Advantageous Effects

According to the above-described embodiments, it is possible to locally and autonomously synchronize clock information with a master anchor on the basis of a master sync signal for each of a plurality of slave anchors that communicates with the master anchor provided for each cell in order to perform wired/wireless hybrid synchronization for a real-time locating system (RTLS) based on an ultra-wideband (UWB), and to reduce the load of the server and to stably and locally perform synchronization even if the network is disconnected.

According to the present embodiments, it is possible to transmit a time difference between reception times of the sync signals that are respectively received from the plurality of master anchors only in a multi-slave anchor that communicates with the plurality of master anchors to a location engine so that the location engine generates an offset value for synchronizing the master anchors, and to perform wired synchronization between a part of the master anchors.

### DESCRIPTION OF DRAWINGS

FIG. 1 is a diagram showing a wireless synchronization apparatus according to an embodiment of the present inventive concept.

FIG. 2 is a flowchart illustrating operations of master anchors, slave anchors, and multi-slave anchors according to the embodiment of the present inventive concept.

FIG. 3 is a flowchart illustrating a wireless synchronization method according to the embodiment of the present inventive concept.

FIG. 4 is a diagram showing a concept of wired synchronization according to the embodiment of the present inventive concept.

FIG. 5 is a diagram showing signal lines of a LAN cable according to the embodiment of the present inventive concept.

FIG. 6 is a diagram showing a wired/wireless hybrid synchronization apparatus according to the embodiment of the present inventive concept.

<Explanation of Symbols for the Main Components of the Drawings>
110: Clock generator
120: Multi-cell synchronization setting device
130: Location engine

### BEST MODE

Hereinafter, exemplary embodiments of the present inventive concept will be described in detail with reference to the accompanying drawings.

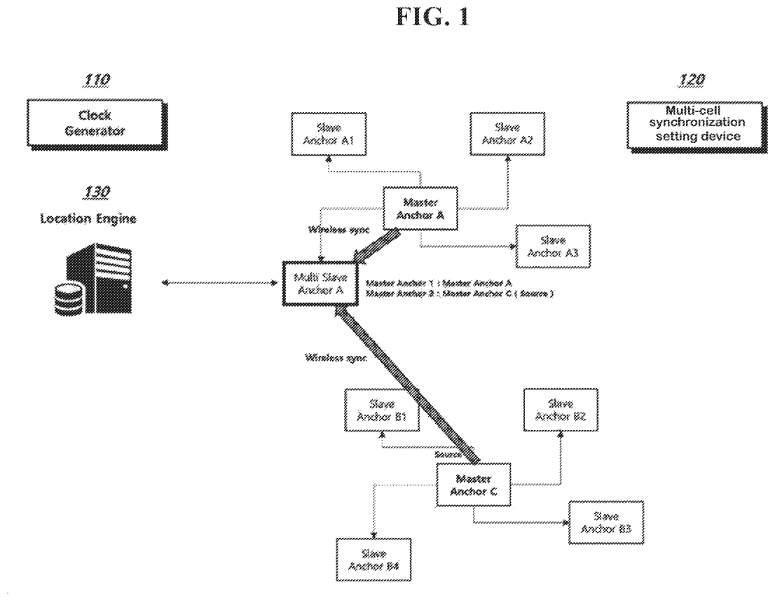

FIG. 1 is a diagram showing a wireless synchronization apparatus according to an embodiment of the present inventive concept.

The wireless synchronization apparatus according to the present embodiment includes a clock generator 110, a multi-cell synchronization setting device 120, a location engine 130, master anchors, slave anchors, and a multi-slave anchor. The components included in the wireless synchronization apparatus are not limiting.

The master anchors, the slave anchors, and the multi-slave anchor are receivers, which precisely synchronize clocks in a wired/wireless manner. The master anchors, the slave anchors, and the multi-slave anchor perform precise synchronization in picos using clock information and sync signals received from the clock generator 110.

According to the present embodiment, n master anchors may be provided in respective cells. The master anchor and the multi slave anchor are configured together in a cell unit.

The clock generator 110 generates clock information of a wireless ultra-wideband (UWB) band and sync signals. The clock generator 110 transmits the clock information and the sync signals to the master anchors connected by a LAN cable.

The location engine 130 is operated in a wireless synchronization method so as to accurately calculate a delay that occurs and reflect the delay to an offset. The location engine 130 collects time differences in the multi-slave anchor, generates an offset value, and synchronizes all the master anchors.

The location engine 130 converts difference values from master anchors of different cells received from the multi-slave anchor into an offset value, and then equally synchronizes the difference values between the master anchors of the different cells. The location engine 130 synchronizes, on the basis of a reference master anchor among the master anchors of the different cells, clocks of the remaining master anchors using the offset value. That is, the location engine 130 equally synchronizes the difference values of the master anchors of the different cells on the basis of the difference values received from the multi-slave anchor.

The location engine 130 synchronizes the clocks of the other master anchors on the basis of the reference master anchor, using difference values received from a plurality of multi-slave anchors.

When receiving the difference values between the master anchors of the different cells from the multi-slave anchor and generating the offset value, the location engine 130 accumulatively reflects the difference values between the master anchors of the different cells, which are subsequently received, to generate the offset value. In other words, the location engine 130 equally synchronizes the difference values of the master anchors of other non-adjacent cells on the basis of the reference master anchor. Since the location engine 130 accumulatively generates the offset value, all the master anchors have the same clock.

The location engine 130 creates a time sync tree map. The location engine 130 may configure a separate tab next to an anchor list on the time sync tree map to display only the master anchors in a tree form.

For example, the location engine 130 may set the master anchors in the order of the master anchor B→the master anchor C→the master anchor A on the time sync tree map, and at the final stage, sums up respective difference values to calculate the result in picos.

The location engine 130 manages a cell time difference between the master anchor A and the master anchor B, and calculates a time difference between reception times of tags as a single time zone. In the case of multi cells (multi master anchors), the location engine 130 applies one same time zone as standard time information for positioning a tag.

In the case of multi-cells of two or more stages, the location engine 130 sums up all time differences from master anchors connected at higher levels, manages the time differences to calculate a reference time. For example, the location engine 130 calculates a value obtained by adding a difference between the master anchor A and the master anchor C and a difference between the master anchor C and the master anchor B as a reference time of an area B.

The location engine 130 converts the difference values into an offset value, and then synchronizes the difference values between the master anchors of different cells on the basis of the offset value. The location engine 130 synchronizes, on the basis of a master source anchor that serves as a reference among master anchors of different cells, clocks of the remaining master anchors using the offset value.

The location engine 130 generates the offset value on the basis of the difference values received from the multi-slave anchor, and then updates the offset value by accumulatively reflecting difference values newly received from the multi-slave anchor in other cells. The location engine 130 equally synchronizes the difference values of master anchors of different non-adjacent cells on the basis of the accumulatively updated offset value. The location engine 130 creates a time sync tree map including master anchors, slave anchors, and a multi-slave anchor, and configures a separate tab next to an anchor list on the time sync tree map to display only the master anchors in a tree form.

The multi-cell synchronization setting device 120 configures one of a plurality of slave anchors as a multi-slave anchor in a cell unit.

The multi-cell synchronization setting device 120 sets two or more master anchors that communicate with the multi-slave anchor. The multi-cell synchronization setting device 120 determines a master source anchor that serves as a reference among at least two or more master anchors that communicate with the multi-slave anchor.

The multi-cell synchronization setting device 120 determines a communication order of the master anchors for each cell. Then, when setting at least two or more master anchors that communicate with the multi-slave anchor, the multi-cell synchronization setting device 120 may automatically set the master anchors according to the communication order of the master anchors. After setting at least two or more master anchors that communicate with the multi-slave anchor and determining the master source anchor that serves as the reference, the multi-cell synchronization setting device 120 calculates the communication order of the master anchors in reverse on the basis of the order of the master source anchor, and shows the result to a user for confirmation.

The master anchor and the slave anchors form a single cell.

The master anchors include a master anchor A (210), a master anchor B (220), and a master anchor C (230). Each master anchor broadcasts a clock sync signal in a wireless manner to surroundings in a cell unit.

The master anchor transmits clock information and the sync signal to a plurality of slave-anchors in each cell. The plurality of master anchors sets a multi-slave anchor for communication.

The slave anchors synchronize timestamps on the basis of the clock of the master anchor.

The slave anchors include a slave anchor A1 (212), a slave anchor A2 (214), a slave anchor A3 (216), a slave anchor B1 (222), a slave anchor B2 (224), a slave anchor B3 (226), a slave anchor C1 (232), a slave anchor C2 (234), a slave anchor C3 (236), and a slave anchor C4 (238).

In a case where a synchronization error occurs in a specific slave anchor, the error may be transmitted to the corresponding master anchor and a server. Each slave anchor time-sequentially receives sync signals from the master anchor at a preset time cycle (for example, 200 ms). In a case where a deviation occurs in the received signals by more than a preset threshold, the slave anchor may recognize that an error has occurred, and generate an error alarm and transmit it the master anchor and the server.

Multi cells are synchronized in a wireless manner to synchronize entire UWB anchors at an accuracy of 1 nano second or less. In the case of each cell, synchronization is performed using the above-mentioned method.

The slave anchor calculates a time difference in hardware using time points at which the clock information is received from the master anchor for each cell, and transmits an arrival time for a TDOA (Time Difference Of Arrival) operation received from a transmitter (tag) to the location engine 130 on the basis of the master anchor.

In the case of multi cells, the multi-slave anchor receives clock information from at least two master anchors, and transmits a time difference between the clock information received from the two master anchors to the location engine 130.

The slave anchor receives a clock sync signal from the master anchor, and locally and autonomously synchronizes clock information with the master anchor on the basis of the clock sync signal. The slave anchor generates local time sync data on the basis of the clock sync signal, and autonomously applies the local time sync data to match its clock with the master anchor's clock.

The slave anchor autonomously applies, in a case where a tag event is received from a tag, the local time sync data to match its clock with the clock of the master anchor, and transmits the tag event received from the tag to the location engine 130. The slave anchor receives the clock sync signal from the master anchor at preset time cycles, and recognizes, in a case where a difference between the time cycles exceeds a preset threshold value, that an error has occurred and generates an error alarm to the location engine.

The multi-slave anchors may include a multi-slave anchor A (218) and a multi-slave anchor B 228. Each multi-slave anchor may receive sync signals from master anchors of different cells. That is, the multi-slave anchor receives signals from two or more master anchors, and performs a synchronization process.

The multi-slave anchor transmits a difference between sync signals received from master anchors of different cells to the server. In this case, the multi-slave anchor calculates a time difference between clock sync signals received from master anchors of different cells, and transmits the result to the location engine 130. The multi-slave anchor should not necessarily exist between cells, and in a case where a seamless operation is necessary, the multi-slave anchor may not exist.

The multi-slave anchor calculates a time difference value of reception times of clock sync signals that are respectively received from a plurality of master anchors in a cell unit, and transmits the result. The multi-slave anchor calculates the time difference value of the reception times of the clock sync signals that are respectively received from the plurality of master anchors using a TDOA algorithm.

The multi-slave anchor communicates with at least two master anchors, and registers master anchor MAC addresses for the master anchors in communication. The multi-slave anchor automatically determines a communication order of the plurality of master anchors in communication on the basis of a communication order of the master anchors of cells. Here, the multi-slave anchor determines the communication order of the master anchors in reverse on the basis of the communication order of the master source anchor that serves as a reference among the plurality of master anchors in communication.

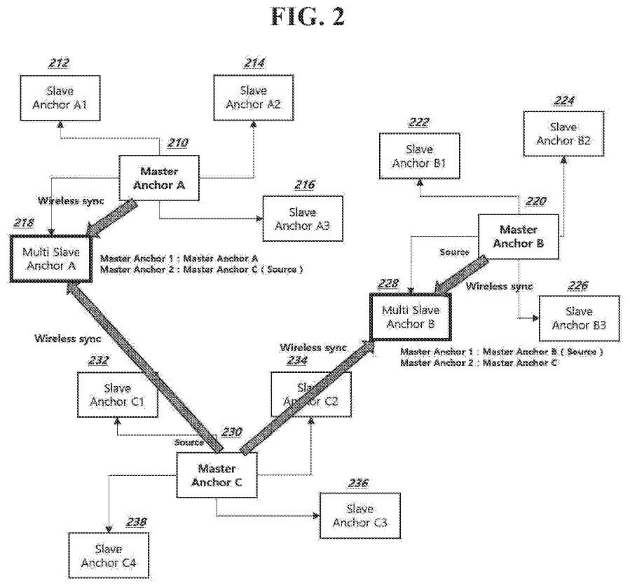

FIG. 2 is a flowchart illustrating operations of master anchors, slave anchors, and multi-slave anchors according to the embodiment of the present inventive concept.

The master anchor A (210) transmits a clock sync signal to the slave anchor A1 (212), the slave anchor A2 (214), the slave anchor A3 (216), and the multi-slave anchor A (218).

The slave anchor A1 (212), the slave anchor A2 (214), the slave anchor A3 (216), and the multi-slave anchor A (218) do not directly transmit reception times of the clock sync signal received from the master anchor A (210) to the location engine 130, but synchronize their clocks with the clock of the master anchor A (210) on the basis of the clock sync information. In other words, the slave anchor A1 (212), the slave anchor A2 (214), the slave anchor A3 (216), and the multi-slave anchor A (218) perform clock synchronization with respect to the master anchor A (210) on the basis of the clock sync information received from the master anchor A (210).

The slave anchor A1 (212), the slave anchor A2 (214), and the slave anchor A3 (216) respectively and autonomously apply their own synchronized clocks. In this way, since the slave anchor A1 (212), the slave anchor A2 (214), and the slave anchor A3 (216) do not need to send the time difference between reception times of the clock sync signal received from the master anchor A (210) to the location engine 130, it is possible to reduce the load of the location engine 130, and to stably and locally perform the synchronization even if the network is disconnected.

The multi-slave anchor A (218) calculates a time difference between reception times of the clock sync signals that are respectively received from the master anchor A (210) and the master anchor C (230), and transmits the result to the location engine 130.

The multi-slave anchor A (218) calculates the time difference between the reception times of the clock sync signals that are respectively received from the master anchor A (210) and the master anchor C (230), using the TDOA algorithm.

The master anchor B (220) transmits the clock sync signal to the slave anchor B1 (222), the slave anchor B2 (224), the slave anchor B3 (226), and the multi-slave anchor B (228).

The slave anchor B1 (222), the slave anchor B2 (224), the slave anchor B3 (226), and the multi-slave anchor B (228) do not directly transmit reception times of the clock sync signals that are received from the master anchor B (220) to the location engine 130, but synchronizes their clocks with the clock of the master anchor B (220) on the basis of the clock sync information. In other words, the slave anchor B1 (222), the slave anchor B2 (224), the slave anchor B3 (226), and the multi-slave anchor B (228) perform clock synchronization with respect to the master anchor B (220) on the basis of the clock sync information received from the master anchor B (220).

The slave anchor B1 (222), the slave anchor B2 (224), and the slave anchor B3 (226) respectively and autonomously apply their own synchronized clocks. In this way, since the slave anchor B1 (222), the slave anchor B2 (224), and the slave anchor B3 (226) do not need to send the time difference between the reception times of the clock sync signal received from the master anchor B (220) to the location engine 130, it is possible to reduce the load of the location engine 130, and to stably and locally perform synchronization even if the network is disconnected.

The multi-slave anchor B (228) calculates a time difference between reception times of the clock sync signals that are respectively received from the master anchor A (210) and the master anchor C (230), and transmits the result to the location engine 130.

The multi-slave anchor B (228) calculates a time difference between reception times of clock sync signals that are respectively received from the master anchor B (220) and the master anchor C (230), respectively, using the TDOA algorithm.

The master anchor C (230) transmits the clock sync signal to a slave anchor C1 (232), a slave anchor C2 (234), a slave anchor C3 (236), and a slave anchor C4 (238).

The slave anchor C1 (232), the slave anchor C2 (234), the slave anchor C3 (236), and the slave anchor C4 (238) do not directly transmit reception times of the clock sync signal received from the master anchor C (230) to the location engine 130, but synchronizes their clocks with the clock of the master anchor C (230) on the basis of the clock sync information. In other words, the slave anchor C1 (232), the slave anchor C2 (234), the slave anchor C3 (236), and the slave anchor C4 (238) perform clock synchronization with respect to the master anchor B (220) on the basis of the clock sync information received from the master anchor C (230).

Each of the slave anchor C1 (232), the slave anchor C2 (234), the slave anchor C3 (236), and the slave anchor C4 (238) applies their own synchronized clocks. In this way, since the slave anchor C1 (232), the slave anchor C2 (234), the slave anchor C3 (236), and the slave anchor C4 (238) do not need to send the time difference between the reception times of the clock sync signal received from the master anchor C (230) to the location engine 130, it is possible to reduce the load of the location engine 130, and to stably and locally perform synchronization even if the network is disconnected.

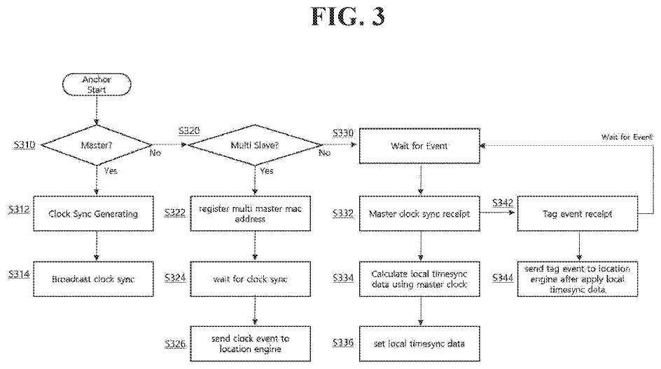

FIG. 3 is a flowchart illustrating a wireless synchronization method according to the embodiment of the present inventive concept.

The multi-cell synchronization setting device 120 checks whether a set anchor is a master anchor (S310). In step S310, in a case where the set anchor is the master anchor, the multi-cell synchronization setting device 120 performs setting so that the master anchor generates a clock sync signal (S312). The master anchor broadcasts the clock sync signal to peripheral slave anchors (S314).

In step S310, in a case where the set anchor is not the master anchor, the multi-cell synchronization setting device 120 checks whether the set anchor is a multi-slave anchor (S320). In step S320, in a case where the set anchor is the multi-slave anchor, the multi-cell synchronization setting device 120 registers master anchor MAC addresses for a plurality of master anchors that communicate with the multi-slave anchor (S322). The multi-slave anchor waits for reception of clock sync signals from the plurality of master anchors (S324). The multi-slave anchor calculates a time difference of the clock sync signals from the plurality of master anchors, and transmits the result to the location engine 130 (S326).

In step S320, in a case where the set anchor is not the multi-slave anchor, the slave anchor waits for reception of the clock sync signal from the master anchor (S330). The slave anchor receives the clock sync signal from the master anchor (S332). The slave anchor calculates local time sync data on the basis of the clock sync signal received from the master anchor (S334). The slave anchor autonomously applies the local time sync data to match its clock with a clock of the master anchor (S336).

The slave anchor receives a tag event from a tag (S342). After autonomously applying the local time sync data to match the clock with the clock of the master anchor, the slave anchor transmits the tag event received from the tag to the location engine 130 (S344).

In FIG. 3, although it is shown that steps S310 to S344 are sequentially executed, the present inventive concept is not limited thereto. In other words, change in the execution order of the steps shown in FIG. 3 or parallel execution of plural steps thereof is possible as necessary.

The wireless synchronization method according to the present embodiment described above with reference to FIG. 3 may be implemented as a program and recorded on a computer-readable recording medium. The computer-readable recording medium on which the program for implementing the wireless synchronization method according to the present embodiment is recorded includes all types of recording devices capable of storing data readable by a computer system.

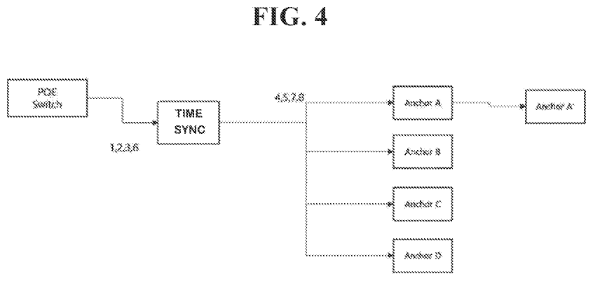

FIG. 4 is a diagram showing a concept of wired synchronization according to the embodiment of the present inventive concept.

In a case where synchronization between master anchors is performed in a wired manner, the master anchors have the same clock in hardware. In a case where there is a curved section or an angled section between cells, only the curved or angled section may be connected in a wired manner so that the master anchors may have the same clock. In a case where the master anchors are connected to each other in a wired manner, the master anchors have the same offset value with the same hardware even in a case where synchronization is not performed.

The clock generator 110 generates a clock at a preset cycle, and transmits the result to the master anchor B (220). The master anchor B (220) periodically transmits a clock signal for synchronization to the master anchor C (230). The master anchor C (230) resets a timer while receiving the clock signal, and sets an offset value to 0.

The multi-cell synchronization setting device 120 has a configuration in which a communication function and a time synchronization function are provided together in one CAT5E cable, to thereby provide a synchronization function through the single cable without a separate cable for wired synchronization.

The multi-cell synchronization setting device 120 uses CAT5E international standard 1, 2, 3, and 6 signal lines for communication. The multi-cell synchronization setting device 120 accurately synchronizes anchors in picos by providing sync signals through auxiliary signal lines 4 and 5 and clock information through auxiliary signal lines 7 and 8 within the CAT5E cable. The master anchor and slave anchor are also mounted with a clock generator function to provide clock information and a sync signal to other slave anchors to enable self-wired synchronization.

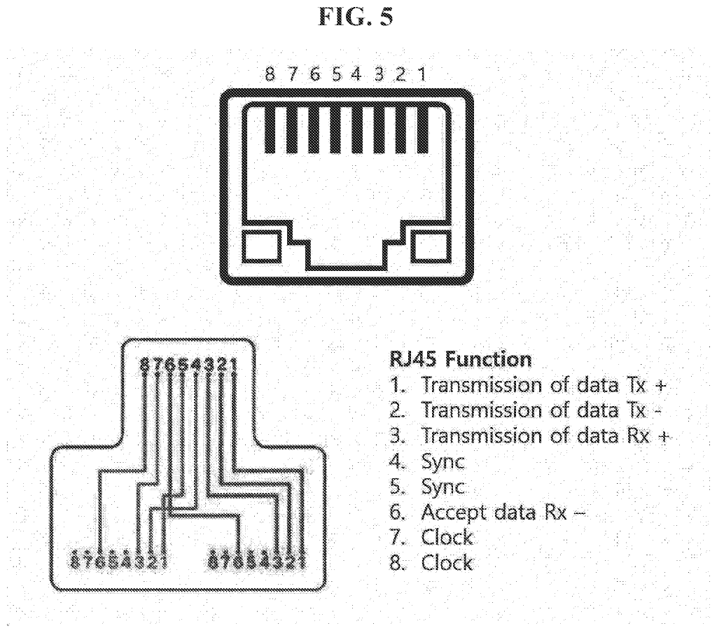

FIG. 5 is a diagram showing signal lines of a LAN cable according to the embodiment of the present inventive concept.

Eight lines are provided in a LAN cable (RJ45). Lines 1, 2, 3, and 6 among the eight lines in the LAN cable are used for general communication. The clock generator 110 transmits sync pulses through lines 4 and 5 in the LAN cable, and transmits clock information through lines 7 and 8. In other words, the clock generator 110 transmits clock information and sync pulses while performing communication, using all eight lines within the LAN cable (RJ45).

The clock generator 110 performs communication and synchronization together using one LAN cable connected to a plurality of anchors. The clock generator 110 is configured so that a plurality of anchors performs communication and synchronization together using only one communication line without a separate cable for synchronization.

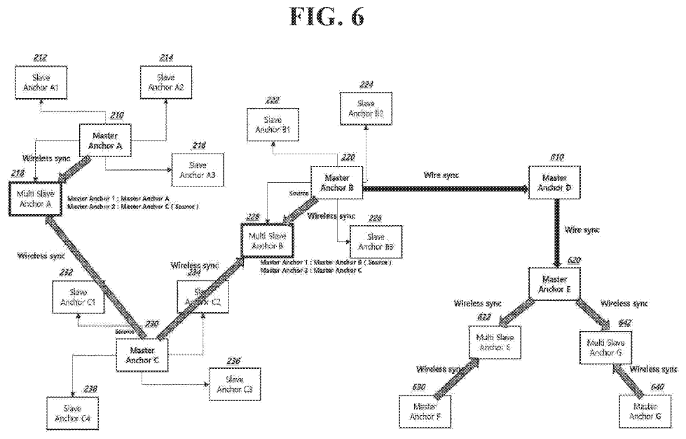

FIG. 6 is a diagram showing a wired/wireless hybrid synchronization apparatus according to the embodiment of the present inventive concept.

The multi-cell synchronization setting device 120 provides hybrid synchronization in which wired and wireless synchronization functions are integrated. In the case of wireless synchronization, LOS (Line of Sight) should be guaranteed. As much as the UWB channel is used for wireless synchronization, there is a limitation in the radio capacity. In the case of wired synchronization, there is no need to calculate a time difference in the location engine 130, to thereby make it possible to reduce the computational load of the engine while securing high accuracy.

In each of the plurality of cells, the slave anchors locally and autonomously synchronize their clocks in a wireless manner according to the configuration of the cell, but in the curved or angled section between cells, the master anchors are connected in a wired manner.

The master anchor A (210) transmits a clock sync signal to the slave anchor A1 (212), the slave anchor A2 (214), the slave anchor A3 (216), and the multi-slave anchor A (218).

The slave anchor A1 (212), the slave anchor A2 (214), the slave anchor A3 (216), and the multi-slave anchor A (218) do not directly transmit reception times of the clock sync signal received from the master anchor A (210) to the location engine 130, but autonomously synchronize their clocks with a clock of the master anchor A (210) on the basis of the clock sync information. In other words, the slave anchor A1 (212), the slave anchor A2 (214), the slave anchor A3 (216), and the multi-slave anchor A (218) perform clock synchronization with respect to the master anchor A (210) on the basis of the clock sync information received from the master anchor A (210).

The slave anchor A1 (212), the slave anchor A2 (214), and the slave anchor A3 (216) respectively and autonomously apply their own synchronized clocks. In this way, since the slave anchor A1 (212), the slave anchor A2 (214), and the slave anchor A3 (216) do not need to send a time difference between reception times of the clock sync signal received from the master anchor A (210) to the location engine 130, it is possible to reduce the load of the location engine 130, and to stably and locally perform the synchronization even if the network is disconnected.

The multi-slave anchor A (218) calculates a time difference between reception times of the clock sync signals that are respectively received from the master anchor A (210) and the master anchor C (230), and transmits the result to the location engine 130.

The multi-slave anchor A (218) calculates the time difference between the reception times of the clock sync signals that are respectively received from the master anchor A (210) and the master anchor C (230), using the TDOA algorithm.

The master anchor B (220) transmits the clock sync signal to the slave anchor B1 (222), the slave anchor B2 (224), the slave anchor B3 (226), and the multi-slave anchor B (228).

The slave anchor B1 (222), the slave anchor B2 (224), the slave anchor B3 (226), and the multi-slave anchor B (228) do not directly transmit reception times of the clock sync signals that are received from the master anchor B (220) to the location engine 130, but autonomously synchronizes their clocks with the clock of the master anchor B (220) on the basis of the clock sync information. In other words, the slave anchor B1 (222), the slave anchor B2 (224), the slave anchor B3 (226), and the multi-slave anchor B (228) perform clock synchronization with respect to the master anchor B (220) on the basis of the clock sync information received from the master anchor B (220).

The slave anchor B1 (222), the slave anchor B2 (224), and the slave anchor B3 (226) respectively and autonomously apply their own synchronized clocks. In this way, since the slave anchor B1 (222), the slave anchor B2 (224), and the slave anchor B3 (226) do not need to send the time difference between the reception times of the clock sync signal received from the master anchor B (220) to the location engine 130, it is possible to reduce the load of the location engine 130, and to stably and locally perform synchronization even if the network is disconnected.

The multi-slave anchor B (228) calculates a time difference between reception times of the clock sync signals that are respectively received from the master anchor A (210) and the master anchor C (230), and transmits the result to the location engine 130.

The multi-slave anchor B (228) calculates a time difference between reception times of the clock sync signals that are respectively received from the master anchor B (220) and the master anchor C (230), respectively, using the TDOA algorithm.

The master anchor C (230) transmits the clock sync signal to a slave anchor C1 (232), a slave anchor C2 (234), a slave anchor C3 (236), and a slave anchor C4 (238).

The slave anchor C1 (232), the slave anchor C2 (234), the slave anchor C3 (236), and the slave anchor C4 (238) do not directly transmit reception times of the clock sync signal received from the master anchor C (230) to the location engine 130, but autonomously synchronizes their clocks with the clock of the master anchor C (230) on the basis of the clock sync information. In other words, the slave anchor C1 (232), the slave anchor C2 (234), the slave anchor C3 (236), and the slave anchor C4 (238) perform clock synchronization with respect to the master anchor B (220) on the basis of the clock sync information received from the master anchor C (230).

Each of the slave anchor C1 (232), the slave anchor C2 (234), the slave anchor C3 (236), and the slave anchor C4 (238) applies their own synchronized clocks. In this way, since the slave anchor C1 (232), the slave anchor C2 (234), the slave anchor C3 (236), and the slave anchor C4 (238) do not need to send the time difference between the reception times of the clock sync signal received from the master anchor C (230) to the location engine 130, it is possible to reduce the load of the location engine 130, and to stably and locally perform synchronization even if the network is disconnected.

The clock generator 110 generates a clock sync signal at a preset cycle.

The master anchor B (220) is connected to the clock generator 110 in a wired manner, and receives the clock sync signal. The master anchor B (220) synchronizes clock information on the basis of the clock sync signal. The master anchor B (220) broadcasts the clock sync signal in a wireless manner to surroundings in a cell unit.

The slave anchor B1 (222), the slave anchor B2 (224), and the slave anchor B3 (226) receive the clock sync signal from the master anchor B (220). The slave anchor B1 (222), the slave anchor B2 (224), and the slave anchor B3 (226) locally and autonomously synchronize clock information with the master anchor B (220) on the basis of the clock sync signal.

The multi-slave anchor B (228) calculates a first difference value between reception times of the clock sync signals that are respectively received from the master anchor B (220) and the master anchor C (230) for transmission.

A master anchor D (610) is connected to the master anchor A (210) in a wired manner, receives the clock sync signal, synchronizes clock information on the basis of the clock sync signal, and broadcasts the clock sync signal in a wireless manner to surroundings in a cell unit.

A master anchor E (620) is connected to the master anchor D (610) in a wired manner, receives the clock sync signal, synchronizes clock information on the basis of the clock sync signal, and broadcasts the clock sync signal in a wireless manner to surroundings in a cell unit.

A slave anchor E1, a slave anchor E2, and a slave anchor E3 receive the clock sync signal from the master anchor E (620). The slave anchor E1, the slave anchor E2, and the slave anchor E3 locally and autonomously synchronize clock information with the master anchor E (620) on the basis of the clock sync signal.

A multi-slave anchor E (622) calculates a second time difference between reception times of the clock sync signals that are respectively received from the master anchor E (620) and a master anchor F (630) for transmission.

The location engine 130 converts the first difference value and the second difference value into an offset value, and then synchronizes the difference values between master anchors of different cells on the basis of the offset value.

The clock generator 110 transmits a communication signal using the signal lines (1, 2, 3, and 6) of the signal lines in the LAN cable connected to the master anchor B (220). The clock generator 110 transmits sync pulses using the signal lines (4 and 5) among the remaining signal lines excluding the signal lines for transmitting the communication signal among the signal lines in the LAN cable. The clock generator 110 transmits clock information using the remaining signal lines excluding the signal lines for transmitting the communication signal and the signal lines for transmitting the sync pulses among the signal lines in the LAN cable. The clock generator 110 transmits the communication signal, the sync pulses, and the clock information through one LAN cable.

The master anchor B (220) and the master anchor D (610) are connected in a wired manner in a curved section or an angled section between cells. The master anchor D (610) and the master anchor E (620) are connected in a wired manner in a curved section or an angled section between cells. The master anchor D (610) is connected to the master anchor B (220) in a wired manner, resets a timer when receiving the clock sync signal, and synchronizes clock information while initializing the offset value.

The master anchor D (610) connected to the master anchor B (220) in a wired manner receives the clock sync signal, and then synchronizes the clock information on the basis of the clock sync signal. The master anchor E (620) is connected to the master anchor D (610) in a wired manner, receives the clock sync signal, and then synchronizes clock information on the basis of the clock sync signal. The master anchor E (620) broadcasts the clock sync signal in a wireless manner to surroundings in a cell unit.

The multi-slave anchor E (622) calculates a difference value between reception times of the clock sync signals that are respectively received from the master anchor E (620) and the master anchor F (630), and transmits the result to the location engine 130. A multi-slave anchor G (642) calculates a difference value between reception times of the clock sync signals that are respectively received from the master anchor E (620) and the master anchor G (640) and transmits the result to the location engine 130.

The above description is merely an example of the technical idea of the present inventive concept, and various modifications and variations can be made to those skilled in the art without departing from the essential characteristics of the present inventive concept. That is, the present embodiments described above are not intended to limit the technical idea of the present inventive concept, and the scope of the technical idea of the present inventive concept is not limited by these embodiments. The scope of the present inventive concept should be construed according to claims, and all technical ideas within the scope equivalent thereto should be construed as being included in the scope of the present inventive concept.

1. A hybrid synchronization apparatus comprising:
a clock generator that generates a clock sync signal at a preset cycle;
a first master anchor that is connected to the clock generator in a wired manner to receive the clock sync signal, synchronizes clock information on the basis of the clock sync signal, and broadcasts the clock sync signal in a wireless manner to surroundings in a cell unit;
a first slave anchor that receives the clock sync signal from the first master anchor, and locally and autonomously synchronizes clock information with the first master anchor on the basis of the clock sync signal;
a first multi-slave anchor that calculates a first difference value between reception times of the clock sync signals that are respectively received from the first master anchor and an N-th master anchor for transmission;
a second master anchor that is connected to the first master anchor in a wired manner to receive the clock sync signal, synchronizes clock information on the basis of the clock sync signal, and broadcasts the clock sync signal in a wireless manner to surroundings in a cell unit;
a second slave anchor that receives the clock sync signal from the second master anchor, and locally and autonomously synchronizes clock information with the second master anchor on the basis of the clock sync signal;
a second multi-slave anchor that calculates a second difference value between reception times of the clock sync signals that are respectively received from the second master anchor and an M-th master anchor for transmission; and
a location engine that converts the first difference value and the second difference value into an offset value, and synchronizes the difference values between the master anchors of different cells on the basis of the offset value.

2. The hybrid synchronization apparatus according to claim 1,
wherein the clock generator transmits a communication signal using a part of signal lines in a LAN cable connected to the first master anchor, transmits sync pulses using a part of the remaining signal lines excluding the signal lines for transmitting the communication signal among the signal lines in the LAN cable, and transmits clock information using a part of the remaining signal lines excluding the signal lines for transmitting the communication signal and the signal lines for transmitting the sync pulses among the signal lines in the LAN cable, to transmit the communication signal, the sync pulses, and the clock information through one LAN cable.

3. The hybrid synchronization apparatus according to claim 2,
wherein the first master anchor and the second master anchor are connected in a wired manner in a curved section or an angled section between cells.

4. The hybrid synchronization apparatus according to claim 3,
wherein the second master anchor is connected to the first master anchor in a wired manner, resets a timer when receiving the clock sync signal, and synchronizes the clock information while initializing the offset value.

5. The hybrid synchronization apparatus according to claim 4,
wherein the first and second slave anchors generate local time sync data on the basis of the clock sync signals, and autonomously applies the local time sync data to match their clocks with clocks of the first and second master anchors.

6. The hybrid synchronization apparatus according to claim 5,
wherein the first and second slave anchors autonomously apply, in a case where a tag event is received from a tag, the local time sync data to match their clocks with the clocks of the first and second master anchors, and then transmit the tag event received from the tag to the location engine.

7. The hybrid synchronization apparatus according to claim 6,
wherein the first and second slave anchors receive the clock sync signals from the first and second master anchors at preset time cycles, and recognize, in a case where a difference between the time cycles exceeds a preset threshold value, that an error has occurred and generate an error alarm to the location engine.

8. The hybrid synchronization apparatus according to claim 7,
wherein the first multi-slave anchor calculates the first difference value between the reception times of the clock sync signals that are respectively received from the first master anchor and the N-th master anchor, using a TODA algorithm, and
wherein the second multi-slave anchor calculates the second difference between the reception times of the clock sync signals that are respectively received from the second master anchor and the M-th master anchor, using the TDOA algorithm.

9. The hybrid synchronization apparatus according to claim 8,
wherein the location engine synchronizes, on the basis of a master source anchor that serves as a reference among master anchors of different cells, clocks of the remaining master anchors using the offset value.

10. The hybrid synchronization apparatus according to claim 9,
wherein the location engine generates the offset value on the basis of the first and second difference values received from the first and second multi-slave anchors, and updates the offset value by accumulatively reflecting difference values newly received from a multi-slave anchor in other cells.

11. The hybrid synchronization apparatus according to claim 10,
wherein the location engine equally synchronizes the difference values of master anchors of different non-adjacent cells on the basis of the accumulatively updated offset value.

12. The hybrid synchronization apparatus according to claim 11,
wherein the first multi-slave anchor communicates with the first master anchor and the N-th master anchor, and registers master anchor MAC addresses for the first master anchor and the N-th master anchor in communication, and
wherein the second multi-slave anchor communicates with the second master anchor and the M-th master anchor, and registers master anchor MAC addresses for the second master anchor and the M-th master anchor in communication.

13. The hybrid synchronization apparatus according to claim 12,
wherein the first multi-slave anchor automatically determines a communication order of the first master anchor and the N-th master anchor in communication according to a communication order of the master anchors for each cell, and
wherein the second multi-slave anchor automatically determines a communication order of the second master anchor and the M-th master anchor in communication according to a communication order of the master anchors for each cell.

14. The hybrid synchronization apparatus according to claim 13,
wherein the first multi-slave anchor determines the communication order of the master anchors in reverse on the basis of the communication order of the master source anchor that serves as the reference among the first master anchor and the N-th master anchor in communication, and
wherein the second multi-slave anchor determines the communication order of the master anchors in reverse on the basis of the communication order of the master source anchor that serves as the reference among the second master anchor and the M-th master anchor in communication.

15. The hybrid synchronization apparatus according to claim 14,
wherein the location engine creates a time sync tree map including the first and second master anchors, the first and second slave anchors, and the first and second multi-slave anchors, and configures a separate tab next to an anchor list on the time sync tree map to display only the master anchors in a tree form.

16. A hybrid synchronization method comprising:
generating a clock sync signal at a preset cycle, by a clock generator;
receiving the clock sync signal from the clock generator that is connected in a wired manner, synchronizing clock information on the basis of the clock sync signal, and broadcasting the clock sync signal in a wireless manner to surroundings in a cell unit, by a first master anchor;
receiving the clock sync signal from the first master anchor, and locally and autonomously synchronizing clock information with the first master anchor on the basis of the clock sync signal, by a first slave anchor;
calculating a first difference value between reception times of the clock sync signals that are respectively received from the first master anchor and an N-th master anchor for transmission, by a first multi-slave anchor;
receiving the clock sync signal from the first master anchor that is connected in a wired manner, synchronizing clock information on the basis of the clock sync signal, and broadcasting the clock sync signal in a wireless manner to surroundings in a cell unit, by a second master anchor;
receiving the clock sync signal from the second master anchor, and locally and autonomously synchronizing clock information with the second master anchor on the basis of the clock sync signal, by a second slave anchor;
calculating a second difference value between reception times of the clock sync signals that are respectively received from the second master anchor and an M-th master anchor for transmission, by a second multi-slave anchor; and
converting the first difference value and the second difference value into an offset value, and synchronizing the difference values between the master anchors of different cells on the basis of the offset value, by a location engine.
